(19) United States
(12) Patent Application Publication
(10) Pub. No.: US 2017/0118828 A1
(43) Pub. Date: Apr. 27, 2017

(54) METHOD AND APPARATUS FOR ALIGNING DISPLAY SUBSTRATE BY RUBBING, METHOD AND SYSTEM FOR PREPARING DISPLAY SUBSTRATE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Jian Li, Beijing (CN); Yuguang Fan, Beijing (CN); Dongzhao Li, Beijing (CN); Yan Yang, Beijing (CN); Jingpeng Li, Beijing (CN); Yujia Wang, Beijing (CN); Yuekai Gao, Beijing (CN)

(21) Appl. No.: 15/204,565

(22) Filed: Jul. 7, 2016

(30) Foreign Application Priority Data
Oct. 26, 2015 (CN) 201510702269.9

(51) Int. Cl. H05F 3/00; G02F 1/1337; G02F 1/13

(52) U.S. Cl. CPC H05F 3/00; G02F 1/1303; G02F 1/133723; G02F 1/133784

(57) ABSTRACT

This disclosure pertains to the technical field of display, and particularly to a method and an apparatus for aligning a display substrate by rubbing as well as a method and a system for preparing a display substrate. This method for aligning a display substrate by rubbing comprises: aligning the surface of the display substrate using a rubbing cloth in a rubbing process; and treating impurity particles produced in the rubbing process after the rubbing process, wherein the charges of the impurity particles are converted or eliminated to eliminate the electrostatic adsorbing effect between the impurity particles and the display substrate so as to remove the impurity particles produced in the rubbing process. Accordingly, an apparatus for aligning a display substrate by rubbing is further provided. This method and apparatus for aligning a display substrate by rubbing are capable of removing the strong “electrostatic adsorbing effect” between a display substrate and impurity particles so as to completely remove foreign matters in cooperation with ultrasonic oscillation or the action of washing and beating by water outside.

### TECHNICAL FIELD

This disclosure pertains to the technical field of display, and particularly to a method and an apparatus for aligning a display substrate by rubbing as well as a method and a system for preparing a display substrate.

### BACKGROUND

The alignment of an alignment film (such as, polyimide, simply referred to as PI) is an important process in the industry of liquid crystal display (simply referred to as LCD). At present, the rubbing process is mostly used in the LCD industry to align the alignment film. In a rubbing process, a rubbing cloth is used to perform rubbing alignments on a color filter substrate and an array substrate, respectively, and a cell-assembling process is then performed. In the rubbing process, the rubbing cloth directly contacts the color filter substrate or the array substrate for rubbing, such that minute particles on the surface of the alignment film are worn out, and a large amount of impurity particles will be produced during this period. Therefore, the color filter substrate and the array substrate are required to be cleaned respectively before cell-assembling the color filter substrate and the array substrate.

At present, the mainstream rubbing cloths include a cotton material and a rayon material. The cotton material is a natural fiber, which has a relatively high molecular weight and less impurity particles peeled off, and the display screen produced therefrom has a bad quality; while most of the nylon materials form a layer of synthetic resin on the surface of fiber, which has a relatively low molecular weight and will easily peel off to produce impurity particles, and the display screen produced therefrom has a good quality. Particularly, in the process of the rubbing alignment for the array substrate, on one hand, serious abrasion will be easily caused to the area of the array substrate which is not coated with the alignment film and debris sticking will be generated, including peeling of the synthetic resin of the rubbing cloth itself or the part of the array substrate surface and the color filter substrate surface themselves worn out by the rubbing cloth; on the other hand, along with the charge accumulation caused by triboattraction, accumulation of rubbing debris or foreign impurity particles is exacerbated.

At present, in the process of cleaning and removing foreign matters in rubbing alignment for the color filter substrate and the array substrate, the foreign matters are removed by physical vibration or washing and beating by water. However, it is difficult to remove these foreign impurity particles by a cleaning process, and “displacement” will occur and these foreign impurity particles are shifted to the display area, which results in badness of bright pixel and affects the display effect.

### SUMMARY

A technical problem to be solved in this disclosure is to provide a method and an apparatus for aligning a display substrate by rubbing as well as a method and a system for preparing a display substrate, with respect to the above shortages present in the prior art. This method and this apparatus for aligning a display substrate by rubbing are capable of removing the strong “electrostatic adsorbing effect” between a display substrate and impurity particles so as to completely remove foreign matters in cooperation with ultrasonic oscillation or the action of washing and beating by water outside.

A technical solution used for solving the technical problem in this disclosure is that this method for aligning a display substrate by rubbing comprises: aligning the surface of the display substrate using a rubbing cloth in a rubbing process; and treating impurity particles produced in the rubbing process after the rubbing process, wherein the charges of the impurity particles are converted or eliminated to eliminate the electrostatic adsorbing effect between the impurity particles and the display substrate so as to remove the impurity particles produced in the rubbing process.

Preferably, the step of converting or eliminating the charges of the impurity particles comprises: converting or eliminating the electric property of the impurity particles produced in the rubbing process by using ions having charges with a single electric property, wherein the electric property of the charges of the ions is the same as the electric property of the charges of the impurity particles, and is opposite to the electric property of the voltage of the display substrate produced by rubbing.

Preferably, furthermore, the method further comprises a step of enhancing the removal of the impurity particles by using auxiliary ions having an electric property of charges opposite to that of the ions having charges with a single electric property.

Preferably, in the step of removing the impurity particles, the method further comprises removing the impurity particles by using an ultrasonic oscillation process.

Preferably, after the ultrasonic oscillation process, the method further comprises a step of removing the impurity particles by using a solvent cleaning method.

Preferably, in the rubbing process, the method further comprises a step of reducing the voltage produced by the rubbing between the impurity particles and the display substrate by using an X-Ray electrostatic elimination method.

Preferably, before the rubbing process, the method further comprises a step of pre-removing environmental foreign matters on the display substrate by using an ultrasonic oscillation process.

A method for preparing a display substrate comprises the method for aligning a display substrate by rubbing described above.

A apparatus for aligning a display substrate by rubbing comprises: a rubbing unit for aligning the surface of the display substrate using a rubbing cloth in a rubbing process; and an impurity particle treatment unit for producing ions and allowing the action between the ions and the impurity particles produced in the rubbing process, such that the charges of the impurity particles are converted or eliminated to eliminate the electrostatic adsorbing effect between the impurity particles and the display substrate and remove the impurity particles produced in the rubbing process.

Preferably, the impurity particle treatment unit comprises an ion production portion and an ion output portion, wherein:

the ion production portion is used for producing ions having electric property of charges which is the same as the electric property of charges of the impurity particles and is opposite to the electric property of the voltage of the display substrate produced by rubbing;

the ion output portion is used for allowing the action between the ions and the impurity particles to convert or eliminate the charges of the impurity particles so as to remove the impurity particles produced in the rubbing process.

Preferably, the impurity particle treatment unit further comprises an ultrasonic oscillation portion which comprises an ultrasonic oscillation chamber, and the ion output portion comprises an ion outputter which outputs ions having charges with a single electric property to the ultrasonic oscillation chamber, wherein the electric property of charges of the ions is the same as the electric property of charges of the impurity particles, and is opposite to the electric property of the display substrate.

Preferably, the ion output portion further comprises an auxiliary ion outputter and the ultrasonic oscillation portion further comprises an auxiliary ultrasonic oscillation chamber, wherein the auxiliary ion outputter outputs auxiliary ions to the auxiliary ultrasonic oscillation outputter, and the electric property of charges of the auxiliary ions is opposite to that of the ions having charges with a single electric property.

Preferably, the impurity particle treatment unit further comprises a solvent cleaning portion which is provided after the ultrasonic oscillation portion.

Preferably, the rubbing unit further comprises an X-Ray electrostatic eliminator used for reducing the voltage produced by the rubbing between the impurity particles and the display substrate during the rubbing process.

Preferably, this apparatus further comprises a pre-cleaning unit as an ultrasonic pre-cleaning portion, which is provided before the rubbing unit and is used for removing environmental foreign matters on the display substrate.

A system for preparing a display substrate comprises the apparatus for aligning a display substrate by rubbing described above.

An advantageous effect of this disclosure is that: the method and the apparatus for aligning a display substrate by rubbing in this disclosure effectively reduce the electrostatic adsorbing effect between foreign impurity particles and the display substrate and are capable of significantly improving the phenomenon of failing to remove debris produced due to rubbing alignment, by introducing charges with a single electric property for electrostatic neutralization or repulsion; and at the meanwhile, it is possible to effectively reduce badness of foreign matters and improve the yield rate of liquid crystal display products in cooperation with a cleaning apparatus such as an ultrasonic oscillator at the same time.

### BRIEF DESCRIPTION OF THE DRAWINGS

FIG. 1 is a schematic diagram of charge distribution in the rubbing process;

FIG. 2 is a schematic diagram of the method for aligning a display substrate by rubbing in Example 1 of this disclosure;

FIG. 3 is a structural schematic diagram of the apparatus for aligning a display substrate by rubbing in Example 1 of this disclosure;

FIG. 4 is a schematic diagram of the method for aligning a display substrate by rubbing in Example 2 of this disclosure; and

FIG. 5 is a structural schematic diagram of the apparatus for aligning a display substrate by rubbing in Example 2 of this disclosure;

in which:

11—rubbing cloth; 12—display substrate; 13—rubbing debris; 21—pre-cleaning unit; 22—rubbing unit; 23—ultrasonic oscillation portion; 24—ion production portion; 25—ion output portion; 26—solvent cleaning portion.

### DETAILED DESCRIPTION

In order to allow the person skilled in the art to better understand the technical solution of this disclosure, the method and the apparatus for aligning a display substrate by rubbing as well as the method and the system for preparing a display substrate in this disclosure will be further described in detail in conjunction with the accompanying drawings and specific embodiments.

The technical concept of this disclosure is that the problem that it is difficult to thoroughly remove impurity particles after the rubbing alignment process in the prior art is because the impurity particles and the display substrate are stubbornly adhered due to the electrostatic effect. Rubbing foreign impurity particles (zara particles) resulted from rubbing are stable at an occurrence of 2%, and there is an outbreak possibility of 100% upon the retention of new products, which results in a relatively substantial problem in sample delivery of new products. At present, however, there has been no effective mechanism to remove the electrostatic effect in the cleaning process yet.

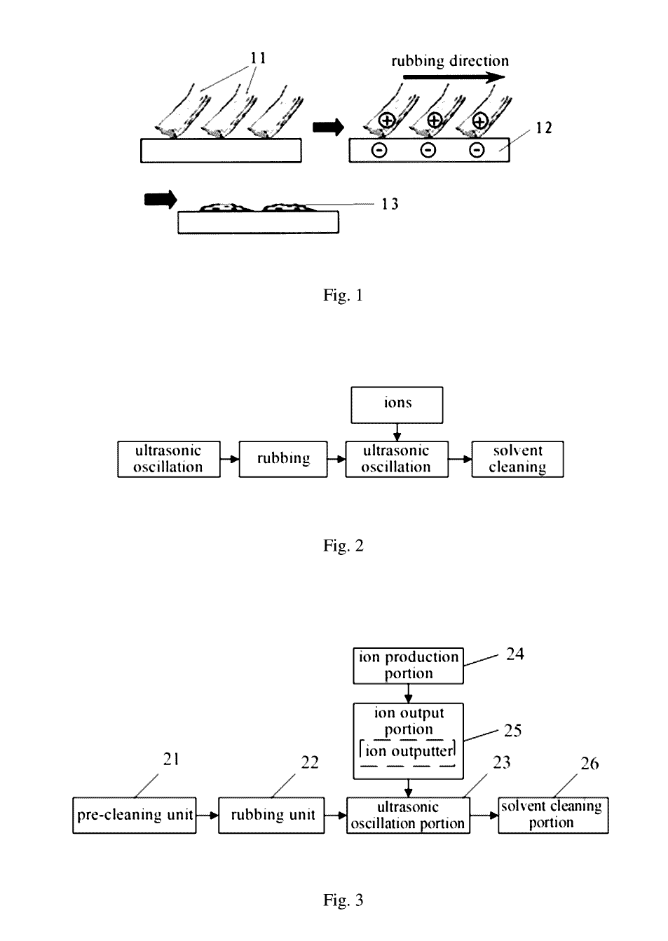

It is found by the inventor through the investigation of a series of experimental data that the reason why foreign impurity particles are difficult to be removed by cleaning and remain in a large amount attributes to the electrostatic adsorbing effect of fibers produced in the rubbing process. As shown in FIG. 1, in the rubbing process, the charges on the rubbing cloth 11 (positive charges, + charges) and the charges on the area of the display substrate 12 which is not covered by the alignment film (negative charges, − charges) are different, resulting in that the rubbing debris 13, which is foreign impurity particles (positive charges, + charges) and the display substrate (negative charges, − charges) adhere to each other instantaneously. The polarity of the display substrate after the rubbing process is relatively strong, and will absorb a large amount of moisture even in an existing cleaning process of removing foreign matters by physical vibration or washing and beating by water without new external charge sources. This results in tight adsorption of foreign matters due to electrostatic adsorption and aqueous containment, and thus it is difficult to achieve a complete cleaning before the cell-assembling of the array substrate and the color filter substrate.

Fortunately, it is found by the inventor through the analysis in the adsorption between the foreign impurity particles and the display substrate that the foreign matters produced in the rubbing alignment are not a stubborn badness but may be removed, indicated by a large amount of data. Thereby, this disclosure has introduced a mechanism of electrostatic repulsion to change charges of the foreign matters and charges of the display substrate to the same charges or eliminate charges of the foreign matters, so as to remove the strong “electrostatic adsorbing effect” between a display substrate and impurity particles and completely remove foreign matters in cooperation with ultrasonic oscillation or the action of washing and beating by water outside.

### Example 1

This Example provides a method for aligning a display substrate by rubbing and its corresponding apparatus for aligning a display substrate by rubbing. This method for aligning a display substrate by rubbing is capable of removing the strong “electrostatic adsorbing effect” between impurity particles and the display substrate so as to completely remove foreign matters. The display substrate herein comprises a color filter substrate and an array substrate to be subjected to an alignment process.

This method for aligning a display substrate by rubbing comprises a step of aligning the surface of a display substrate using a rubbing cloth, and further comprises a step of treating impurity particles produced in the rubbing process after the rubbing process to convert or eliminate charges of the impurity particles, so as to eliminate the electrostatic adsorbing effect between the impurity particles and the display substrate and remove the impurity particles produced in the rubbing process.

As shown in FIG. 2, this method for aligning a display substrate by rubbing specifically comprises:

Before the rubbing process, a step of removing environmental foreign matters on the display substrate by using an ultrasonic oscillation (ultrasound cleaning baths, simply referred to as USC) method is performed, by which foreign matters are preliminarily removed. The principle thereof is that the foreign impurity particles on the display substrate are vibrated off by ultrasonic oscillation and then are withdrawn by vacuum for foreign matter removal. In the ultrasonic oscillation process herein, settings may be an ultrasonic frequency of 60 Hz, a base speed of 40-150 mm/s, an upper adsorption pressure of −0.5 kPa, and a lower adsorption pressure of 12 kPa.

In fact, however, the electrostatic adsorbing effect between the foreign impurity particles and the display substrate is far greater than the external vibration or beating, and it is difficult to thoroughly remove the impurity particles.

In the rubbing process, a step of reducing the voltage produced by the rubbing between the impurity particles and the display substrate by using an X-Ray electrostatic elimination method is further comprised. In this step, the display substrate formally passes through the rubbing cloth for rubbing. It can be known from aforementioned contents that there is a very strong electrostatic effect (the highest electrostatic may be up to 100V) between the impurity particles and the display substrate, and X-Ray is used here to neutralize static electricity, i.e., X-Ray is used for electrostatic elimination, so as to prevent the circuit of the display substrate from being broken down due to transient high voltage produced by rubbing. Typically, soft X-Ray is used to remove a part of static electricity (an X-Ray in a range of 1-10 Angstroms is known as soft X-Ray). However, soft X-Ray can only remove a part of the static electricity. In the rubbing process, since the tip of the rubbing cloth and the display substrate are in transient rubbing, X-Ray has a limited capacity of covering areas and eliminating charges, and the foreign impurity particles produced by the alignment film are still strongly adsorbed on the display substrate, resulting in that it is difficult for soft X-Ray to achieve the object of thoroughly eliminating charges. It has been found through a long-term analysis of foreign impurity particles that the transient voltage can be only reduced to the extent of not breaking down the display substrate by using the X-Ray electrostatic elimination method, and a large amount of foreign impurity particles (+ charges) and the display substrate (− charges) still adhere to each other, whereas the electrostatic adsorbing effect in subsequent processes will continue to allow the adsorption of peeled foreign matters of the rubbing cloth and debris of the alignment film.

After the process on rubbing, the step of converting or eliminating the charges of the impurity particles comprises converting or eliminating the electric property of the impurity particles produced in the rubbing process by using ions having charges with a single electric property, wherein the electric property of charges of the ions is the same as the electric property of charges of the impurity particles, and is opposite to the electric property of the voltage of the display substrate produced by rubbing. Next, by using an ultrasonic oscillation process, a step of removing the impurity particles which have not been removed by using ions having charges with a single electric property is further comprised.

In the process, the display substrate is cleaned by the ultrasonic oscillation process again to remove foreign matters, while charges of impurity particles are converted or eliminated with ions. That is, air is ionized to produce a large amount of positive ions and negative ions, and according to the electric property of charges of foreign impurity particles (for example, if the display substrate carries “− charges”, it adsorbs foreign impurity particles carrying “+ charges”), and separate “+ charges” are outputted at this time, and a mechanism of electrostatic neutralization or repulsion is used to change charges of the foreign impurity particles and charges of the display substrate to the same charges or eliminate charges of foreign impurity particles, so as to remove the strong “electrostatic adsorbing effect” between both of them and reduce the adhesion between the foreign impurity particles and the display substrate while the impurity particles are removed in cooperation with ultrasonic oscillation. Then, in the ultrasonic oscillation and the subsequent solvent cleaning method, the foreign impurity particles are removed in cooperation with ultrasonic oscillation or the action of washing and beating by water outside. About 90% of zara impurity particles which are about 5 μm may be cleaned by performing the ultrasonic oscillation process twice in cooperation with the removal of the electrostatic adsorbing effect.

After the process of ultrasonic oscillation, a step of removing the impurity particles by using a solvent cleaning method (the cleaning is performed by a solvent cleaning method) is further comprised. The solvent herein may include: DIW (deionized water) or IPA (isopropanol) or a mixed solvent containing DIW (deionized water), and other similar surfactant solutions. In this step, the electrostatic adsorbing effect between the impurity particles and the display substrate in the rubbing process has been substantially eliminated, and the adhesion effect between the display substrate and the impurity particles will not be exacerbated by long-term exposure of the display substrate in the air. After the ultrasonic oscillation, the cleaning by solvent is further performed, and the removal rate of impurity particles can be nearly up to 100% so as to ensure the cleanness of the display substrate and ensure the yield rate and the image quality of the display substrate.

Accordingly, this example provides an apparatus for aligning a display substrate by rubbing, which comprises a rubbing unit for aligning the surface of a display substrate using a rubbing cloth, and further comprises an impurity particle treatment unit. As shown in FIG. 3, the apparatus for aligning a display substrate by rubbing comprises a pre-cleaning unit 21, an impurity particle treatment unit, and a solvent cleaning portion 26, wherein: the impurity particle treatment unit is used for producing ions and allows the action between the ions and the impurity particles produced in the rubbing process, such that the charges of the impurity particles are converted or eliminated to eliminate the electrostatic adsorbing effect between the impurity particles and the display substrate and remove the impurity particles produced in the rubbing process.

Particularly, the pre-cleaning unit 21, which is an ultrasonic pre-cleaning portion, is provided before the rubbing unit 22 and is used for removing the environmental foreign matters on the display substrate.

The rubbing unit 22 further comprises an X-Ray electrostatic eliminator, which is used for reducing the voltage produced by the rubbing between the impurity particles and the display substrate during the rubbing process.

The impurity particle treatment unit comprises an ultrasonic oscillation portion 23, an ion production portion 24 and an ion output portion 25, wherein:

the ion production portion 24 is used for producing ions having electric property of charges which is the same as the electric property of charges of the impurity particles and is opposite to the electric property of the voltage of the display substrate produced by rubbing;

the ion output portion 25 is used for allowing the action between the ions and the impurity particles to convert or eliminate the charges of the impurity particles so as to remove the impurity particles produced in the rubbing process.

The ultrasonic oscillation portion 23 comprises an ultrasonic oscillation chamber, and the ion output portion 25 comprises an ion outputter which outputs ions having charges with a single electric property to the ultrasonic oscillation chamber, wherein the electric property of charges of the ions is the same as the electric property of charges of the impurity particles, and is opposite to the electric property of the display substrate.

In the operational process of the apparatus for aligning a display substrate by rubbing of this example (the process of aligning a display substrate by rubbing), an ion outputter is additionally mounted in the ultrasonic oscillation portion 23. Air is ionized to produce a large amount of positive ions and negative ions, and according to the electric property of charges of foreign impurity particles (for example, if the display substrate carries “− charges”, it adsorbs foreign impurity particles carrying “+ charges”), and separate “+ charges” are outputted at this time and a mechanism of electrostatic neutralization or repulsion is used to change charges of foreign impurity particles and charges of the display substrate to the same charges or eliminate charges of foreign impurity particles, so as to remove the strong “electrostatic adsorbing effect” between both of them and reduce the adhesion between the foreign impurity particles and the display substrate while the impurity particles are removed in cooperation with ultrasonic oscillation. Then, in cooperation with the ultrasonic oscillation and the subsequent solvent cleaning method, the foreign impurity particles are removed by using ultrasonic oscillation or the action of washing and beating by water outside.

Furthermore, the impurity particle treatment unit further comprises a solvent cleaning portion 26, which is provided after the ultrasonic oscillation portion 23.

It will be easily understood that the method for aligning a display substrate by rubbing in this Example may further use an existing cleaning apparatus for a display substrate in order for further cleaning (for example, a specific method for organic impurity particles or other particles with various sizes). A corresponding cleaning system is used for cleaning to remove impurity particles more thoroughly and obtain a clean display substrate. It is not specifically defined herein.

In the method and the apparatus for aligning a display substrate by rubbing in this Example, ion charges having an electric property which is the same as the electric property of charges of the impurity particles and is opposite to the electric property of the voltage of the display substrate are additionally used in the removal of charges of the impurity particles. Compared to the removal of charges of the impurity particles using only soft X-Ray electrostatic elimination, it will more effectively reduce the adhesion between the impurity particles and the display substrate so as to thoroughly remove the impurity particles.

### Example 2

This Example provides a method for aligning a display substrate by rubbing and its corresponding apparatus for aligning a display substrate by rubbing. This method for aligning a display substrate by rubbing is capable of removing the strong “electrostatic adsorbing effect” between impurity particles and the display substrate so as to completely remove foreign matters.

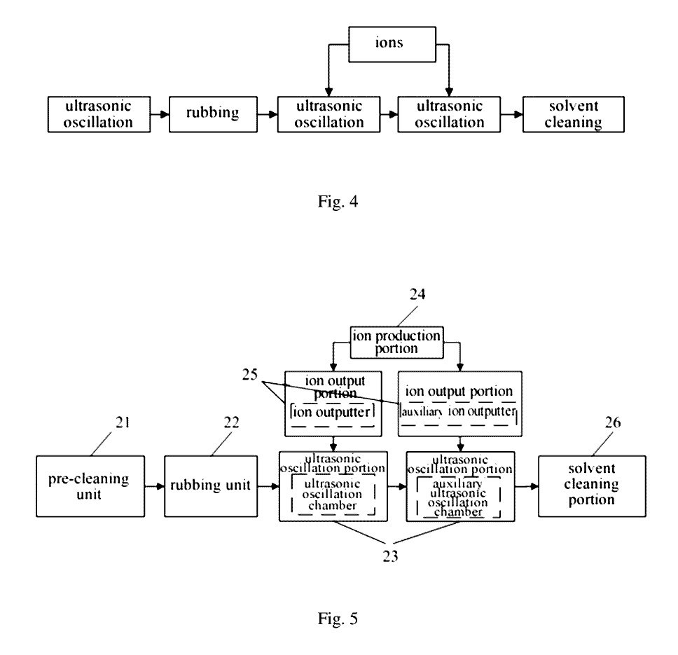

As shown in FIG. 4, compared to the method for aligning a display substrate by rubbing and its corresponding apparatus in Example 1, the method for aligning a display substrate by rubbing in this Example further comprises, after the process of ultrasonic oscillation, a step of enhancing the removal of the impurity particles by using auxiliary ions having an electric property of charges opposite to that of the ions having charges with a single electric property. By the action of secondary ions, the foreign impurity particles having charges with the opposite electric property, which have not been removed in the previous stage of process, can be further removed to obtain a cleaner display substrate.

Accordingly, as shown in FIG. 5, compared to the method for aligning a display substrate by rubbing and its corresponding apparatus in Example 1, in the apparatus for aligning a display substrate by rubbing in this Example, the ion output portion 25 further comprises an auxiliary ion outputter and the ultrasonic oscillation portion 23 further comprises an auxiliary ultrasonic oscillation chamber, wherein the auxiliary ion outputter outputs auxiliary ions to the auxiliary ultrasonic oscillation chamber and the electric property of charges of the auxiliary ions is opposite to that of the ions having charges with a single electric property. By the action of secondary ions performed by the auxiliary ion outputter, charges of the foreign impurity particles with the opposite electric property, which have not been removed in the previous stage of process, can be further removed to obtain a cleaner display substrate.

In the operational process of the apparatus for aligning a display substrate by rubbing of this Example (the process for aligning display substrate by rubbing), an ion outputter and an auxiliary ion outputter are additionally mounted in the ultrasonic oscillation portion 23. Air is ionized to produce a large amount of positive ions and negative ions, and according to the electric property of charges of foreign impurity particles (for example, if the display substrate carries “− charges”, it adsorbs foreign impurity particles carrying “+ charges”), and separate “+ charges” are outputted at this time and a mechanism of electrostatic neutralization or repulsion is used to change charges of foreign impurity particles and charges of the display substrate to the same charges or eliminate charges of foreign impurity particles, so as to remove the strong “electrostatic adsorbing effect” between both of them and reduce the adhesion between the foreign impurity particles and the display substrate while the impurity particles are removed in cooperation with ultrasonic oscillation. Thereafter, separate “− charges” are outputted, and the impurity particles having charges with the opposite electric property are removed and charges of foreign impurity particles with the opposite electric property are neutralized, in cooperation with ultrasonic vibration. Then, in cooperation with the ultrasonic oscillation and the subsequent solvent cleaning method, the foreign impurity particles are removed by using ultrasonic oscillation or the action of washing and beating by water outside.

Compared to the method for aligning a display substrate by rubbing and its corresponding apparatus for aligning a display substrate by rubbing in Example 1, the method for aligning a display substrate by rubbing of this Example has a better effect of removing impurity particles and can obtain a cleaner display substrate.

### Example 3

This Example provides a method for preparing a display substrate and its corresponding system for preparing a display substrate, and a high-quality display substrate can be obtained and a high-quality display apparatus can be further obtained.

This method for preparing a display substrate comprises the method for aligning a display substrate by rubbing in Example 1 or Example 2 to obtain a cleaner and high-quality display substrate.

This system for preparing a display substrate comprises the apparatus for aligning a display substrate by rubbing in Example 1 or Example 2 to obtain a cleaner and high-quality display substrate.

Display apparatuses, which can be obtained from this display substrate, includes any products or members having the function of display, such as liquid crystal panels, electronic papers, cell phones, tablet computers, televisions, displays, laptops, digital photo frames, navigators, etc.

The method and the apparatus for aligning a display substrate by rubbing in this disclosure effectively reduce the electrostatic adsorbing effect between foreign impurity particles and the display substrate and are capable of significantly improving the phenomenon of failing to remove debris produced due to rubbing alignment, by introducing charges with a single electric property for electrostatic neutralization or repulsion; and at the meanwhile, it is possible to effectively reduce badness of foreign matters and improve the yield rate of liquid crystal display products in cooperation with a cleaning apparatus such as an ultrasonic oscillator at the same time.

This method and this apparatus for aligning a display substrate by rubbing are suitable for the improvement of rubbing alignment processes with rubbing cloths of a cotton material and rubbing cloths of a nylon material, and are particularly suitable for the improvement of rubbing alignment with the rubbing cloths of a nylon material.

It can be understood that the above embodiments are merely exemplary embodiments used for illustrating the principle of this disclosure. However, this disclosure is not limited thereto. With respect to those of ordinary skill in the art, various variations and modifications can be made without departing from the spirit and the substance of this disclosure. These variations and modifications are also considered as the scope protected by this disclosure.

What is claimed is:

1. A method for aligning a display substrate by rubbing, comprising:
aligning the surface of the display substrate using a rubbing cloth in a rubbing process; and
treating impurity particles produced in the rubbing process after the rubbing process, wherein charges of the impurity particles are converted or eliminated to eliminate an electrostatic adsorbing effect between the impurity particles and the display substrate so as to remove the impurity particles produced in the rubbing process.

2. The method for aligning a display substrate by rubbing according to claim 1, wherein the step of converting or eliminating charges of the impurity particles comprises:
converting or eliminating an electric property of the impurity particles produced in the rubbing process by using ions having charges with a single electric property, wherein an electric property of the charges of the ions is the same as the electric property of the charges of the impurity particles, and is opposite to an electric property of a voltage of the display substrate produced by rubbing.

3. The method for aligning a display substrate by rubbing according to claim 2, wherein the method further comprises enhancing removal of the impurity particles by using auxiliary ions having an electric property of charges opposite to that of the ions having charges with a single electric property.

4. The method for aligning a display substrate by rubbing according to claim 2, wherein in the step of treating and removing the impurity particles, the method further comprises removing the impurity particles by using an ultrasonic oscillation process.

5. The method for aligning a display substrate by rubbing according to claim 4, wherein after the ultrasonic oscillation process, the method further comprises a step of removing the impurity particles by using a solvent cleaning method.

6. The method for aligning a display substrate by rubbing according to claim 1, wherein in the rubbing process, the method further comprises reducing a voltage produced by the rubbing between the impurity particles and the display substrate, by using an X-Ray electrostatic elimination method.

7. The method for aligning a display substrate by rubbing according to claim 1, wherein before the rubbing process, the method further comprises pre-removing environmental foreign matters on the display substrate by using an ultrasonic oscillation process.

8. A method for preparing a display substrate, comprising the method for aligning a display substrate by rubbing according to claim 1.

9. An apparatus for aligning a display substrate by rubbing, comprising:
a rubbing unit for aligning the surface of the display substrate using a rubbing cloth in a rubbing process; and
an impurity particle treatment unit for producing ions and allowing interaction between the ions and impurity particles produced in the rubbing process, such that charges of the impurity particles are converted or eliminated to eliminate an electrostatic adsorbing effect between the impurity particles and the display substrate and remove the impurity particles produced in the rubbing process.

10. The apparatus for aligning a display substrate by rubbing according to claim 9, wherein the impurity particle treatment unit comprises:
an ion production portion for producing the ions having an electric property of charges which is the same as an electric property of charges of the impurity particles and is opposite to an electric property of a voltage of the display substrate produced by rubbing; and
an ion output portion for allowing the action between the ions and the impurity particles to convert or eliminate the charges of the impurity particles so as to remove the impurity particles produced in the rubbing process.

11. The apparatus for aligning a display substrate by rubbing according to claim 10, wherein the impurity particle treatment unit further comprises an ultrasonic oscillation portion which comprises an ultrasonic oscillation chamber, and the ion output portion comprises an ion outputter which outputs the ions having charges with a single electric property to the ultrasonic oscillation chamber, wherein the electric property of charges of the ions is the same as the electric property of charges of the impurity particles, and is opposite to the electric property of the display substrate.

12. The apparatus for aligning a display substrate by rubbing according to claim 11, wherein the ion output portion further comprises an auxiliary ion outputter and the ultrasonic oscillation portion further comprises an auxiliary ultrasonic oscillation chamber, wherein the auxiliary ion outputter outputs auxiliary ions to the auxiliary ultrasonic oscillation outputter, and an electric property of charges of the auxiliary ions is opposite to that of the ions having charges with a single electric property.

13. The apparatus for aligning a display substrate by rubbing according to claim 11, wherein the impurity particle treatment unit further comprises a solvent cleaning portion which is provided after the ultrasonic oscillation portion.

14. The apparatus for aligning a display substrate by rubbing according to claim 9, wherein the rubbing unit further comprises an X-Ray electrostatic eliminator configured for reducing the voltage produced by the rubbing between the impurity particles and the display substrate during the rubbing process.

15. The apparatus for aligning a display substrate by rubbing according to claim 9, further comprising a pre-cleaning unit as an ultrasonic pre-cleaning portion, which is provided before the rubbing unit and is operable for removing environmental foreign matters on the display substrate.

16. A system for preparing a display substrate, comprising the apparatus for aligning a display substrate by rubbing according to claim 9.
